(19) United States
(12) Patent Application Publication
(10) Pub. No.: US 2019/0212102 A1
(43) Pub. Date: Jul. 11, 2019

(54) Personal Safety Baton

(71) Applicant: Walter Shannon, Louisville, KY (US)

(72) Inventor: Walter Shannon, Louisville, KY (US)

(21) Appl. No.: 15/865,334

(22) Filed: Jan. 9, 2018

(51) Int. Cl. F41H 9/10; F41B 15/02; G08B 7/06; G08B 15/00; G08B 21/02

(52) U.S. Cl. CPC F41H 9/10; F41B 15/02; F21L 4/005; G08B 15/004; G08B 21/0297; G08B 7/06

(57) ABSTRACT

A wearable safety baton that incorporates a chemical irritant spray, an audible alarm, and LED lamps integrated into the body and a shoulder strap in combination with additional features such as a rechargeable battery for charging portable electronic devices, and a storage compartment.

### TECHNICAL FIELD

The apparatus of the present application relates generally portable safety devices. More particularly the apparatus of the present application relates to wearable portable safety devices for runners and cyclists.

### BACKGROUND

Personal safety devices have long been employed in a variety of situation where the user may be at risk. Motorists changing a tire at night bear the risk of being hit by an oncoming vehicle due to low visibility. Hikers in remote areas run the risk of getting lost and losing navigation and communication when the batteries on their personal electronic communication devices are drained of power. Runners, bicycle riders, and walkers face potential harm from low visibility, from attack, from dead batteries in personal electronic devices, and from the loss of keys and other valuable. Multiple devices are currently needed to meet the needs of users in various risky situations.

### SUMMARY

The present application discloses a personal safety device capable of use in self-defense as a baton and which produces an audible alarm. The device also possesses a strap which permits it to be worn over the shoulder or across the back so that it may be carried hands-free. The device possesses a plurality of battery powered lamps along the length of the baton body and the strap to provide increased visibility of the wearer or user from both in front and from behind the wearer. Each lamp is battery powered and may be a light emitting diode (LED). In a further embodiment, the device possesses a programmable control system to control the power to lamps to sequence the emittance of light. A battery is housed within the body to power the lamps. The battery may be a rechargeable battery.

In a further embodiment, the battery system housed within the body may be of the type used to charge portable electronic devices. The device may possess an integrated micro-USB, LIGHTENING, and/or proprietary charging port.

In yet another embodiment, the body possesses a storage compartment for the holding of keys and other valuables for the convenience of the user. The storage compartment may be located on one end of the body and sealed with a cap that is affixed by the engagement of threads or by a friction fit arrangement.

One embodiment of the device utilizes a stored, pressurized chemical irritant canister and a triggering mechanism to spray the chemical irritant out of the far end of the body at an attacker.

Another embodiment of the device implements a registerable unique identifier so that, in the case of an emergency, the user can be identified, emergency contacts notified, and a critically important medical information can be provided to first responders.

The present apparatus recognizes and addresses the previously-mentioned long-felt needs and provides utility in meeting those needs in its various possible embodiments. To one of skill in this art who has the benefits of this disclosure's teachings, other and further objects and advantages will be clear, as well as others inherent therein. The disclosures herein are not intended to limit the scope of the invention, merely to provide context with which to understand the patent claims.

### BRIEF DESCRIPTION OF THE DRAWINGS

FIG. 1 depicts a right-side perspective view of an embodiment the device.

FIG. 2 depicts an right-side perspective exploded view of a lamp assembly of the device.

FIG. 3 depicts a partial right-side perspective cross-sectional view of an embodiment of the device showing the control circuit, battery, powered lamp, and ports.

FIG. 4 depicts a partial right-side perspective cross-sectional view of an embodiment of the device showing sound apertures, aperture cover, speaker, and control board.

FIG. 5 depicts a partial right-side perspective cutaway view of an embodiment of the device showing the end of the device housing a chemical spray mechanism, components, and trigger.

FIG. 6 depicts a partial cutaway perspective view of an embodiment of the base of the device showing the storage compartment.

FIG. 7 depicts an exploded perspective view of a storage compartment in the elongated shaft of the device.

### DETAILED DESCRIPTION

Reference is made herein to the attached drawings. Like reference numerals are used throughout the drawings to depict like or similar elements of the personal safety device 100 of the present invention. For the purposes of presenting a brief and clear description of the device of the present application, several embodiments will be discussed as used for providing a personal safety device 100, i.e. safety baton, that can be utilized privately, by security personnel, or by others in environments where visibility is important and may need to be combined with self-defense features. The figures are intended for representative purposes only and should not be considered limiting in any respect. The written descriptions of various embodiments of the device, including embodiments labeled as preferred, are not intended to limit the device by specifically requiring the presence of those embodiments and are merely intended to demonstrate various commercial configurations that employ the spirit of the invention without limiting what is claims to any specific embodiment. The use of the word “preferred” when discussing the embodiments is not intended to specifically identify the preferred embodiment of the invention under patent law, only to indicate non-limiting preferences among numerous potential embodiments.

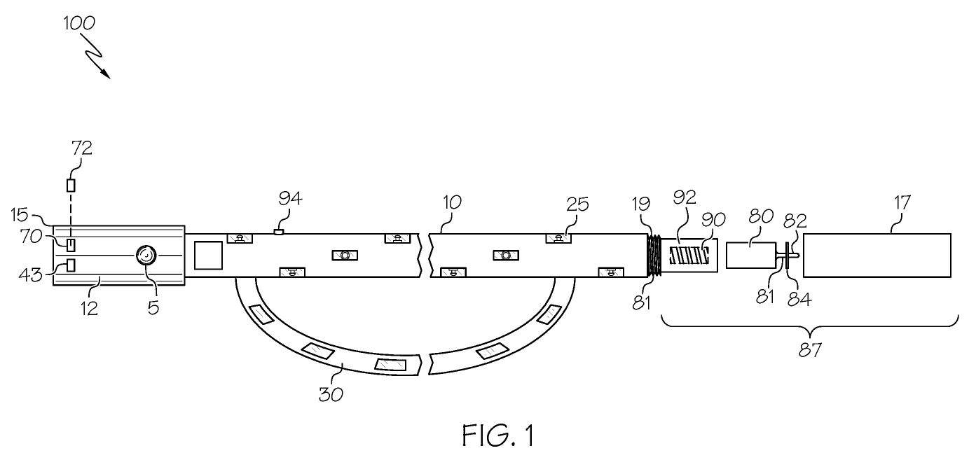

Referring to FIG. 1, there is shown a side view of the safety baton 100 described in the present application. The safety baton 100 comprises a baton body 10 having an elongated length, a first end 15, and a second end 19. A strap 30 is affixed to the body 10 to allow the safety baton 100 to be worn. Ideally, the strap 30 is affixed at the first end 15 and the second end 19 to permit the safety baton 100 to be worn over the shoulder or across the back. The first end 15 of the body 10 possesses a grip 12, i.e. handle, secured to the body 10 that permits a user to effectively grab and manipulate the baton 100 using their hand or hands.

The baton 100 is intended to be useful as a self-defense weapon when swung at predators, animal and human. Ideally, the body 10 is manufactured from metal or a similarly hard substance to not only avoid damage to the baton 100 but also to inflict damage if necessary by striking an assailant or object. The baton 100 may also be used keep assailants at a safe distance by extending the reach of the user.

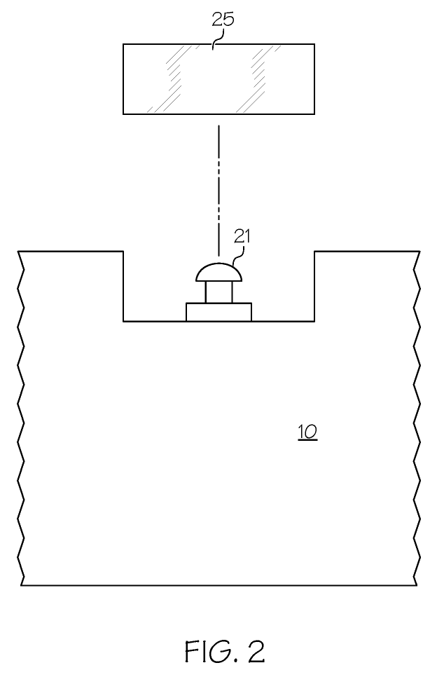

Nighttime visibility is an important safety consideration addressed by the baton 100. Referring to FIG. 2, lamps 21 are integrated into the strap 30 and body 10 along and around its length and are protected by lamp covers 25. Light emitting diodes (LEDs) are particularly useful as lamps 21 as they are extremely energy efficient and can withstand stresses that incandescent, halogen, fluorescent, and compact fluorescent bulbs cannot. LEDs use half as much energy as CFLs (and 90% less than incandescent), and can last up to 10 years. Also, with LEDs, very little heat is lost by radiation, which means that the light beam generated by an LED is cool unlike the light emitted by other sources. Ideally the lamps 21 extend substantially from the first end 15 to the second end 19. The strap 30 also possesses integrated lamps 21. The lamps 21 may be activated by a power switch 5 located on or adjacent to the grip 12, preferably at or adjacent to the grip 12.

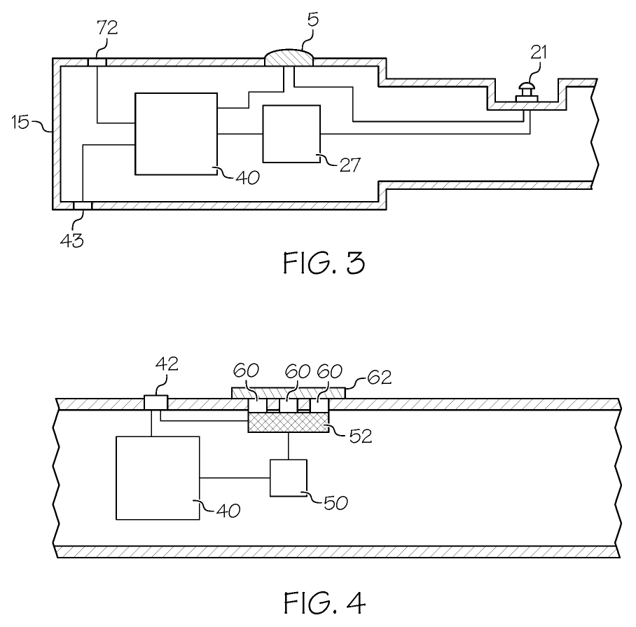

In one embodiment, referring to FIG. 3, the power switch 5 is a push button type lamp switch 5 that merely cycles the power for the lamps 21 on and off. In a further embodiment, the baton 100 possesses a control system 27 in communication with the lamps 21 and utilizes a multi-function type lamp switch 5 that permits the user to cycle through programmed settings such as differing levels of brightness, flashing, and sequenced chasing. In a still further embodiment, a plurality of lamp switches 5 are available, which each regulating different attributes of control, e.g. brightness and flashing, available over the lamps 21. The control system 27 may also be programmed by the user to via a computer or smartphone in communication with the control system 27 to achieve various aesthetic effects in some embodiments. Outfitted a such, the baton 100 can also be used decoratively or used to draw attention in low-light environments. For example, a user could hang the baton 100 from a door or mailbox to help guide invitees to the correct residence.

The lamps 21 are powered by direct current (DC) using at least one battery 40 housed within the body 10. Preferably, the battery 40 is rechargeable and the body 10 possesses a recharging port 43 to which a charging cord 45 may be connected. A lithium-ion rechargeable battery 40 is the preferred chemistry, but other rechargeable battery chemistries are envisioned to be useful. Battery 40 selection for various embodiments would be based on numerous variables including, but not limited to, specific energy, internal resistance, cycle life, overcharge tolerance, and dissipation rate, coulombic efficiency, toxicity, and cost. In an alternative embodiment, the battery 40 is removable and replaceable.

The illumination provided by the wearable safety baton 100 improves safety for riders, runners, and walkers at night by improving visibility to drivers and others of the presence of a person on a sidewalk or roadway and, when participating as a group, it also enables the riders, runners, and walkers to keep each other in sight from the front and the rear for safety considerations. The device 100 is also useful in other activities where people can become separated or otherwise need to be found, such as hiking, camping, skiing, and boating.

In a further embodiment of the baton 100, referring to FIG. 4, an audible panic alarm is generated by an audible alarm circuit 50 and transducer 52, e.g. speaker, housed within the baton 100 and powered by the battery 40. Ideally, the body 10 has speaker apertures 60 to facilitate the emanation of sound from the transducer 52 within the body 10. The apertures 60 are preferably covered with a watertight and puncture resistant aperture covering 62 to inhibit the introduction of contaminants into the body 10 through the apertures 60. The audible alarm is preferably actuated by a panic button switch 42 to turn the audible alarm on and off. When the panic button 42, i.e. alarm switch, is pushed, an audible alarm is generated within the baton 100. In further alternative embodiments, a visual alarm is generated from the lamps 21 either alone or in combination with the audible alarm when the panic button 42 is pressed. Such an alarm is meant to draw attention to the user so as to ward off the attacker by increasing the chance they will be identified or apprehended.

In another embodiment of the baton 100 the battery 40 powers charging ports 70 integrated into the baton 100 for the electrical charging/powering of portable electronic devices such as smartphones. The prior art is replete with useful rechargeable battery and charging system technologies that would be applicable, such as U.S. Pat. No. 6,018,229. Current technology would suggest the inclusion of at least a LIGHTENING and/or micro-USB ports configuration(s), but it is envisioned that one skilled in the art could readily integrate other proprietary port configurations without undue experimentation. The charging ports 70 are integrated into the body 10 at the first end 15. The charging ports 70 would preferably utilize means to seal the ports 72 to inhibit the introduction of moisture and other contaminants, e.g. sweat and dirt. Means to seal the ports 72 could include, but are not limited to covers and non-conductive plugs. In a useful embodiment, the charging ports 70 and battery 40 are capable of preferably delivering at least 1.0 amp of current and more preferably capable of delivering at least 2.0 amps of current. In a further preferred embodiment, the baton 100 is envisioned to be integrated with a proprietary quick charge technology, such as QUALCOMM QUICK CHARGE, to provide faster charging in emergency situations.

Given the ever-increasing reliance on smart phones for communication and safety, a dead cell phone can be a major inconvenience and even a dangerous problem riders, runners, walkers, and others. For example, hikers have been known to get lost in the wild for days, bike riders and have been known to have accidents that leave them undiscovered for extended periods of time, and even walkers are known to have had their cell phone batteries go dead while walking through dangerous neighborhoods. Having a portable power source 40 and charging port 70 integrated into a wearable, illuminated self-defense baton 100 would provide an additional element of protection to the user at critical times of need.

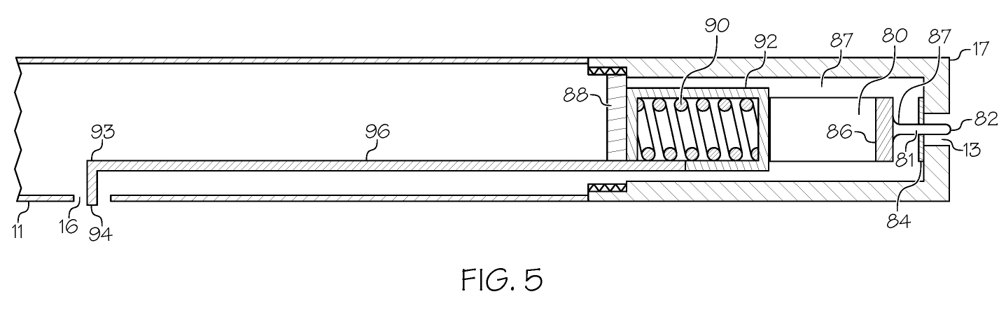

Referring to FIG. 1 and FIG. 5, an additional feature in a further embodiment of the safety baton 100 integrates a chemical irritant containing spray canister 80 at the second end 19. The canister 80 is inserted into the body 10 at the second end 19 by removing a cap 17 that conceals a canister holding chamber 87. The cap 17 is preferably is secured in a threaded engagement with the body 10. The cap 17 possesses a spray aperture 13 through which the pressurized contents are discharged. The pressurized canister 80 may be of the type disclosed in U.S. Pat. No. 5,509,581, which is incorporated herein by reference in its entirety. The canister has a tubular discharge nozzle 82 at its forward end through which the pressurized contents of the canister 80 are released. The prior art is replete with examples of common mechanisms, i.e. means to discharge a pressurized canister 80, that would be useful in releasing the chemical irritant, e.g. U.S. Pat. No. 6,386,726 and U.S. Pat. No. 7,744,471.

One embodiment of a means to trigger the release of the contents of a pressurized canister 80 involves releasing a loaded spring 90 beneath the canister 80 to mechanically advance the canister 80 toward the cap 17 forcing the nozzle 82 into the canister to release the contents of the canister 80. The nozzle 82 possesses a nozzle stem 81 that passes through the 87 affixed to the cap 17. When the spring 90 is released, the canister 80 is advanced toward the cap 17 and forces the nozzle 82 into the canister 80 through a canister seal 86 thus releasing the pressurized contents. The spring 90 is housed within a spring sleeve 92 which is affixed to a spring trigger 94 by a connecting rod 96. The trigger 94 is a stop affixed to the connecting rod trigger end 93 which protrudes into the body wall 11 through a trigger orifice 16 which acts as a stop. The trigger 94 is accessible to the user through the trigger orifice 16. The loaded spring 90 is released and the contents of the pressurized canister 80 are dispersed by depressing the trigger 94 into the body 10 and past the body wall 11 which acts as a stop. The connecting rod 96 is tensioned, like a leaf spring, toward the trigger orifice 16. When the trigger 94 is depressed the connecting rod 96 is released and the spring 90 is then capable of expanding and acts as a piston, driving the canister 80 toward the cap 17 where the nozzle catch 84 engages the nozzle stop 85. The nozzle catch 84 engages the nozzle stop 85 before the canister is fully advanced, thus forcing the nozzle 82 into the canister 80 and through the seal 86 to release the pressurized contents. After each use, the spring 90 and trigger 94 must be reset by forcing the sleeve 92 and spring 90 down onto the spring stop 88 towards the first end 15 and a new canister 80 must be installed.

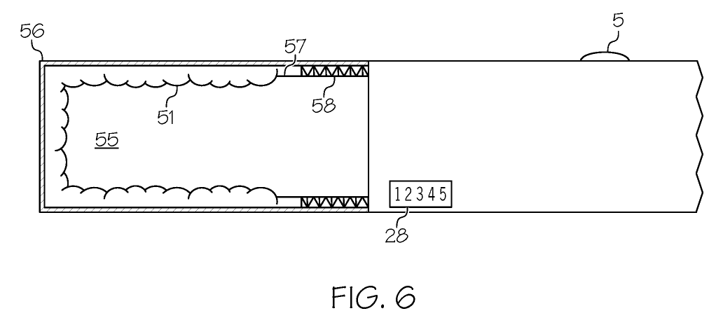

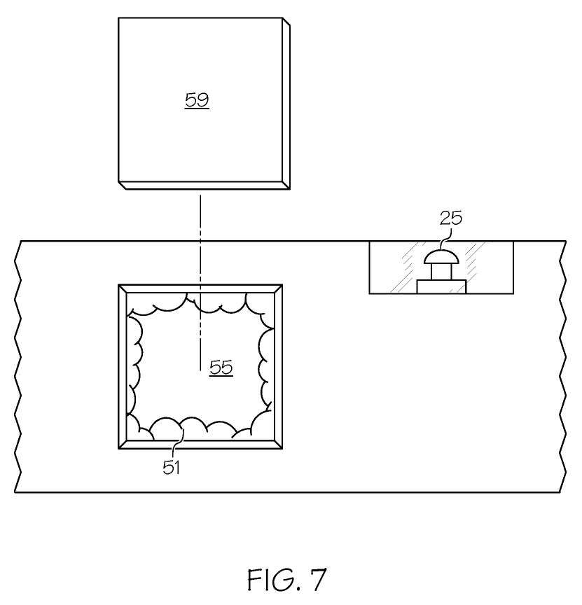

Referring to FIG. 6, a further feature of the device 100 is the presence of a storage compartment 55 within the first end 15. The storage compartment 55 possesses a means to secure the storage compartment 55 to seal the storage compartment 55 and retain its contents. The means to secure the storage compartment 55 may be in the form of a plug that slides into or onto the first end 15 and which forms a friction fit with the first end 15 is the storage compartment is within the first end 15. The means to secure the storage compartment 55 may alternatively be a cap 56 that possess cap threads 57 that are received by cap receiving threads 58 on the first end 15. Alternatively, referring to FIG. 7, the storage compartment 55 can be constructed within the body 10 at a point along its length between the first end 15 and the second end 19 and sealed by a compartment door 56. The storage compartment 55 is alternatively lined with padding 51 to reduce noise, protect contents, and to restrict the movement of the contents stored therein. The storage compartment 55 may be utilized to hold keys, identification, or other contents may be inserted therein as well as other items that would facilitate the safety and/or convenience of the user, e.g. a chemical irritant canister for hand use or as a replacement for one utilized with the device 100 in embodiments that utilize chemical irritant canisters 80.

In an alternative embodiment, the device 100 may possess a serial number 28 or other unique identifier and indicates at least one method of communication with a registry through which the identification and contact information of the owner may be obtained and emergency contact information can be provided. Alternatively, medical data could also be made securely available to verified first responders through such a system.

Referring now to FIG. 8, the serial number 28 acts as an individual device identifier which can be registered along with as much, or as little, information as the user desires to provide. Two tiers of disclosure are provided from a registry portal: (1) non-confidential contact and medical information, and (2) confidential contact and medical information. It is presumed that the user will want to distinguish between information that should be freely available to anyone that has that serial number, and information that should only be available by and/or through verified first responders, e.g. police, fire, and emergency medical technicians.

Non-confidential contact information can be as basic as the device owner's name and the name and telephone number of an emergency contact. Non-confidential medical information is likely to include blood type, serious allergies (e.g. latex, bee venom, penicillin), and critical ailments that others need to be aware of such as diabetes, epilepsy, and heart conditions. Confidential information provides more detailed information such as home address, family members and their contact information, medical insurance provider information, social security number, personal physician contact information, medical history, etc.

What is claimed is:

1. A personal safety device comprising:
a) an elongated shaft having a body, a first end, and a second end;
b) a grip integrated into said body at said first end;
c) an audible alarm system;
d) a strap affixed to said body at or near said first end and at or near said second end; and
e) a battery housed within said shaft in wired communication with a plurality of lamps integrated into said shaft and said strap, said lamps being powered by said battery.

2. The device of claim 1, wherein a lamp power switch is integrated into said first end and is in wired communication with said lamps and said battery.

3. The device of claim 2, further comprising a means to select a preprogrammed timing sequence to the activation and deactivation of said lamps.

4. The device of claim 1, wherein said strap has an adjustable length.

5. The device of claim 1, wherein said battery is rechargeable.

6. The device of claim 5, further comprising at least one charging port for portable electronic devices in wired communication with said battery.

7. The device of claim 1, further comprising a visual alarm.

8. The device of claim 1, further comprising a canister containing a pressurized chemical irritant housed within said second end and a means to trigger the release of said chemical irritant from said canister.

9. The device of claim 1, wherein

10. The device of claim 1, further comprising a sealable storage compartment within said body.

11. The device of claim 10, wherein said storage compartment is padded.

12. The device of claim 10, wherein said storage compartment is located between said first end and said second end and is sealed by a storage compartment access door.

13. The device of claim 10, wherein said storage compartment is sited within said first end or said second end and is sealed by a cap.

14. The device of claim 13, wherein said cap is secured to said body by a threaded coupling of said cap and said body, or by a friction fit.

15. The device of claim 1, further comprising a registrable unique identifier that permits a third party to identify the owner and identify the owner's emergency contact.

16. A personal safety device comprising:
a) an elongated shaft having a body, a first end, and a second end;
b) a grip integrated into said body at said first end;
c) an audible alarm system;
d) a strap affixed to said body at or near said first end and at or near said second end;
e) a rechargeable battery housed within said shaft in wired communication with a plurality of lamps integrated into said shaft and said strap, said lamps being powered by said rechargeable battery; and
f) a canister containing a pressurized chemical irritant housed within said second end and a means to trigger the release of said chemical irritant from said canister.

17. The device of claim 16, further comprising at least one charging port for portable electronic devices in wired communication with said rechargeable battery.

18. The device of claim 16, further comprising a registrable unique identifier that permits a third party to identify the owner and identify the owner's emergency contact.

19. The device of claim 16, further comprising a storage compartment.

20. A personal safety device comprising:
a) an elongated shaft having a body, a first end, and a second end;
b) a grip integrated into said body at said first end;
c) an audible alarm system;
d) a strap affixed to said body at or near said first end and at or near said second end;
e) a rechargeable battery housed within said shaft in wired communication with a plurality of lamps integrated into said shaft and said strap, said lamps being powered by said rechargeable battery;
f) at least one charging port for portable electronic devices in wired communication with said rechargeable battery;
g) a registrable unique identifier that permits a third party to identify the owner and identify the owner's emergency contact; and
h) a storage compartment.
